(19) United States
(12) Patent Application Publication
(10) Pub. No.: US 2008/0285952 A1
(43) Pub. Date: Nov. 20, 2008

(54) Internet-Based Digital Content Recording System and Method

(75) Inventors: Arthur L. Cohen, Cupertino, CA (US); Alan Czeszynski, Pleasanton, CA (US)

Correspondence Address: STAINBROOK & STAINBROOK, LLP, 412 AVIATION BOULEVARD, SUITE H, SANTA ROSA, CA, 95403, US

(73) Assignee: AERIELLE TECHNOLOGIES, INC., MOUNTAIN VIEW, CA (US)

(21) Appl. No.: 12/096,744

(22) PCT Filed: Dec. 8, 2006
(86) PCT No.: PCT/US06/61814

§ 371 Date: Jun. 9, 2008

Related U.S. Application Data
(60) Provisional application No. 60/749,314, filed on Dec. 9, 2005.

(51) Int. Cl. H04N 5/91; H04N 7/26

(52) U.S. Cl. 386/104; 386/124

(57) ABSTRACT

An Internet-based digital content recording system and method which obviates the need to utilize an analog system or to address the logistical demands of physically preparing a recording medium and ensuring that it is adequate to the task and set to commence recording at the appropriate time. The invention system allows radio listeners to record and enjoy a favorite radio program at any time, in any location. It opens the user's radio experience to include any online radio station around the world, including commercial, public, and personal stations. It provides this functionality through a seamless combination of online and hardware-based interfaces that deliver a consistent user experience.

### BACKGROUND OF THE INVENTION

1. Technical Field

The present invention relates generally to digital recording devices, and more particularly to an internet-based digital content recording system and method.

2. Background Art

Radio listeners arc routinely frustrated by inconvenient programming. It is a common experience to learn that a long-sought after program or music will be aired at a time when it is impossible to hear the broadcast for any of a number of reasons. To name a few such reasons: a radio will not be available to listen to; a radio is available but a signal cannot be picked up; or the broadcast is taking place at the same time another program is being aired. The solution in the past has been to provide and use an analog recording device and either record the program oneself or have a friend record it.

Several options are available for the selective digital recording of televison content. These devices are caller Digital Video Recorders (DVR). These systems provide the customer the ability to record television video content from cable or satellite television signals. Subscribers are provided with the ability to record live television signals for replay at a different time.

DIRECTTV® has provided satellite based telecommunications services for several years and its dish satellite customers accounted for about two-thirds of TIVO® subscribers by the end of October 2004. DIRECTTV is also expected to continue offering TIVO-based recorders at least through early 2007, when its contract with TIVO Inc ends. (DIRECTV is a registered trademark of DirectTV, Inc., of El Segundo, Calif. TIVO is a registered trademark of the Tivo Corporation of Sunnyvale, Calif.)

Scientific-Atlanta Inc is a provider of cable boxes, and its DVR models make up nearly 40 percent of its shipments. It recently announced the first deployment of its multi-room DVR to some Time Warner Cable customers. The company indicated that it would provide a DVR with a DVD recorder so that users can take their recorded programs on the road (TiVo Inc now offers a similar feature but programs must first be transferred to a computer over a home network).

EchoStar provides satellite based telecommunications services, and its DISH NETWORK™ unveiled a DVR in 2004 receiver that also had 100 hours of space for video-on-demand content, a fast-growing revenue generator for cable companies. The satellite provider also introduced a line of portable media players that can connect to the DVRs and download recorded content for playback on the go. (DISH NETWORK is a trademark of EchoStar Satellite, LLC, of Englewood, Colo.)

Motorola Inc, another cable box provider whose DVR models are shipping to Comcast and others, has plans to deploy a more advanced version, including one using Moxi Digital Inc's MOXI platform. (MOXI® is a registered trademark of Moxi Digital Inc of Palo Alto, Calif.)

Hewlett-Packard Co introduced a media hub using the Linux operating system, a machine that includes a DVR and two high-definition TV tuners, enabling recording of two channels simultaneously.

All of these systems relate to the capture of video information from television signals, but they do not apply to radio broadcasts or the capture of internet content.

Currently, thousands of traditional radio stations around the world simultaneously stream audio programming. Internet-based music services such as ITUNES® offer internet based radio stations to users in nearly every genre imaginable. Pandora.com offers samples from the “Music Genome Project”, matching musical styles, lyrics and genre to user preferences, allowing the customer to sore the user created stations on the web site, all at no cost. The user, however has no means to record the content supplied by the service. (ITUNES is a registered trademark of Apple Computer Inc, of Cupertino, Calif.)

In addition, XM and Sirius satellite radio systems stream online, as do countless other Internet-only stations. The vast amount of available programming generates conflicts, as users desire to listen to programs that are broadcast at the same time on different stations, or at times that are inconvenient or impossible for the user to access the content.

Several United States patents also merit at least a passing consideration.

U.S. Pat. No. 6,665,234, to Goodman, et al., discloses a personal audio recorder in a vehicular entertainment sound system. However, the steps needed to successfully record a program for suitable playback are quite complicated.

U.S. Pat. No. 6,622,166, to Gile, et al., discloses an apparatus and method for allowing a user to acquire and record information from the Internet. The system comprises a user interface that allows the user to identify at least one information service on the Internet that provides desired information and to select a desired completion time. A scheduler calculates a launch time to allow the desired information to be downloaded and recorded in its entirety before the desired completion time. A recording dispatcher begins downloading at the launch time the desired information from the information service. A recording device records the desired information to a recording medium.

U.S. Pat. No. 7,065,778, to Lu, describes method and system for providing media from remote locations enables a user to utilize a personalized video recorder (PVR) to order and receive specific television shows that are unavailable from his or her television content provider. Specifically, the PVR is coupled to the Internet such that it can receive an electronic programming guide (EPG) containing worldwide television programming from an EPG server computer. The PVR user utilizes the EPG to request delivery of a specific television show that is typically unavailable to him or her. Upon reception of the request, the EPG server computer locates via the Internet a PVR situated within a broadcast region of the requested television show. Next, the EPG server computer programs the PVR to record the requested television show when it is broadcast. Once the PVR records the television show, it is transmitted to the EPG server computer which transmits it to the requesting PVR.

The foregoing patents reflect the current state of the art of which the present inventor is aware. Reference to, and discussion of, these patents is intended to aid in discharging Applicant's acknowledged duty of candor in disclosing information that may be relevant to the examination of claims to the present invention. However, it is respectfully submitted that none of the above-indicated patents disclose, teach, suggest, show, or otherwise render obvious, either singly or when considered in combination, the invention described and claimed herein.

### DISCLOSURE OF INVENTION

The present invention is an internet-based digital content recording system and method.

The Internet-based digital content recording system and method of the present invention obviates the need to utilize an analog system or to address the logistical demands of physically preparing a recording medium and ensuring that it is adequate to the task and set to commence recording at the appropriate time. The present invention allows radio listeners to enjoy a favorite radio program at any time, in any location. It opens the user's radio experience to include any online radio station around the world, including commercial, public, and personal stations. It provides this functionality through a seamless combination of online and hardware-based interfaces that deliver a consistent user experience. The networked effect helps build brand loyalty and encourages increased market share by building a positive reputation with consumers and by initiating groundbreaking trends.

It is therefore an object of the present invention to provide a combined hardware and online service product that allows users to eliminate time and location dependencies from broadcast and online streaming audio content through utilization of a programmable consumer audio device, such as a Personal Audio Recorder (PAR), and tapping into sources of digital on-line radio.

It is another object of the present invention to combine a PAR with a sophisticated and flexible online tool that combine to break time and location barriers; in effect, a time shifting method and apparatus.

A further object of the present invention to leverages the networked affect on an online community in which users can share their favorite programs, station lists, and the custom “virtual” radio stations that are made possible by the PAR technology.

The Internet-based digital content recording system and method of the present invention, includes three functional units: (1) a programmable radio, which combines a base station/Personal Audio Recorder (PAR) and a portable storage and playback device to which a signal is routed through a broadband router connected to the Internet; (2) a Web-based service interface; and (3) a wireless network service and user information database to collect, store, organize, and deliver streaming digital content services to consumers listening to radio. The core hardware comprising the inventive system is a programmable radio and base station/Personal Audio Recorder (PAR). THE PAR, however, has the capability to record video and/or other related content.

The programmable radio is programmable with station lists generated by the user through the online service, it is programmable with play lists of content on the user's home portable or remote computer, also generated through the online service and provides a base station/(PAR) for time shifting online content and removing time barriers from radio listening. Additionally, it includes a docking station for a removable storage device to download content from the base station/(PAR). Further, it will be appreciated that the PAR can be managed from any device having a web browser or other suitable Internet interface, including, most notably at present cell phones, though it is contemplated that many alternative devices with such functionality will be conceived and provided in the very near future. Accordingly, the PAR may be portable, and it may also be integrated into the automobile.

The programmable radio has stand-alone broadband connectivity through a wireless broadband router. This eliminates the need to have an active music or Internet radio station server running on a separate computer feeding the radio content, while also providing connectivity to the user's personal computer for accessing audio files stored on the computer.

The programmable radio also includes an Ethernet port, and a PC card slot for an optional WiFi or cellular broadband card. It includes a digital content storage system in which to record, and from which to play, the content.

The programmable radio is programmed through an intuitive user interface that allows selection of the Internet radio station or play list content. The station lists, custom stations, play lists, and recording schedule are then sent to the programmable radio once completed on-line. The radio's interface allows the user to intuitively navigate through these options.

The feature that differentiates the inventive system and method from all other Internet radio hardware is that it allows the user to receive and store digital content for selective playback at any location, any time, and as frequently as desired. The programmable radio serves as a docking station for a portable digital audio player. The radio user interface allows the user to push recorded content to the digital audio player for playback when and where the user prefers.

An on-line Internet-based service interface provides the user with a control center through which users direct the inclusion of desired content.

The wireless network service and user information database includes means for creating and storing a user information database with persistent user information such as account information, volatile user information(such as station and playlist menus, and premium content. The user accesses the program guide and selects the streaming digital content through the Internet-based user interface. Once connected, the programmable radio can be programmed to receive and record any digital content made available through the network service at the program time.

User non-associated, aggregated use data is collected about the entire market for sale to content providers. Additional data may be collected, from user's who elect to participate in a program that gives bonus premium-content points for use of extended demographic data.

Content providers may provide premium content through an arbitrated access portal to the premium content through its online service, and handle revenue collection and servicing for the content providers. This content may include subscription-based online music services, private on-line stations, and special events broadcasts.

The service can also include WiFi enabled mobile computing or audio devices, such as personal digital assistants (PDA), mobile phones, or (in the future) WiFi enabled car radios.

There has thus been broadly outlined the more important features of the invention in order that the detailed description that follows may be better understood, and in order that the present contribution to the art maybe better appreciated. Additional objects, advantages and novel features of the invention will be set forth in part in the description as follows, and in part will become apparent to those skilled in the art upon examination of the following. Furthermore, such objects, advantages and features may be learned by practice of the invention, or may be realized and attained by means of the instrumentalities and combinations particularly pointed out in the appended claims.

Still other objects and advantages of the present invention will become readily apparent to those skilled in this art from the following detailed description, which shows and describes only the preferred embodiments of tho invention, simply by way of illustration of the best mode now contemplated of carrying out the invention. As will be realized, the invention is capable of modification in various obvious respects without departing from the invention. Accordingly, the drawings and description of the preferred embodiment are to be regarded as illustrative in nature, and not as restrictive.

### BRIEF DESCRIPTION OF THE DRAWINGS

FIG. 1 is a schematic flow chart showing the operational and structural elements comprising the Internet-based digital content recording system and method of the present invention.

### DRAWING REFERENCE NUMERALS

100 internet-based digital content recording system
110 programmable radio
120 base station/Personal Audio Recorder (PAR)
130 portable storage and playback device
140 broadband router
150 Internet
160 docking station
170 optional WiFi or cellular broadband card
180 hard drive-based storage
200 web-based service interface
210 station and program guides
220 Intelligent agent interface
230 search—sort—select features
240 Intelligent recommendations
250 design a station utility
260 share custom designed stations
300 user information database
310 persistent user information
320 volatile user information
330 premium content
340 program guide
350 streaming digital content
400 WiFi enabled mobile computing or audio devices
500 content providers
510 content arbitrator
520 revenue collection and servicing

### BEST MODE FOR CARRYING OUT THE INVENTION

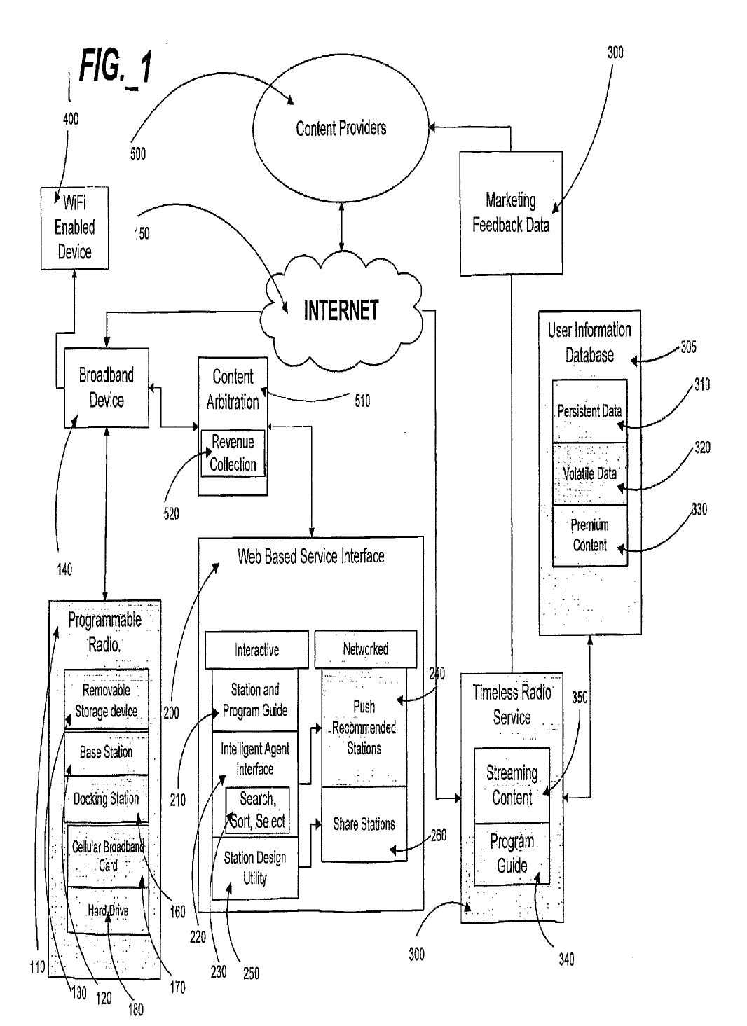

Referring to FIG. 1, wherein like reference numerals refer to like components in the various views, there is illustrated therein a an internet-based digital content recording system and method. generally denominated 100 herein.

FIG. 1 illustrates a first preferred embodiment of the an internet-based digital content recording system and method. 100 of the present invention, includes three functional units: (1) a programmable radio 110, which combines a base station/Personal Audio Recorder (PAR) 120 and a portable storage and playback device 130 to which a signal is routed through a broadband router 140 connected to the Internet 150; (2) an Web-based service interface 200; and (3) and a wireless network service and user information database 300 to collect, store, organize, and deliver streaming digital content services to consumers listening to radio.

Programmable Radio: The core hardware comprising the inventive system is a programmable radio 110 and base station/Personal Audio Recorder (PAR) 120. The programmable radio 110 includes the following functionality:

Firstly, it is programmable with station lists generated by the user through the online service.

Next, it is programmable with play lists of content on the user's home computer, also generated through the online service.

In addition, it provides a base station/(PAR) 120 for time shifting online content and removing time barriers from radio listening.

Further still, it includes a docking station 160 for IPOD® or another MP3 removable storage device 130 to download content from the base station/(PAR) 120 and removing location barriers from radio listening.

Moreover, it has stand-alone broadband connectivity through, for instance, a wireless broadband router 140. This eliminates the need to have an active music or Internet radio station server running on a separate computer feeding the radio content.

And yet still further, it provides seamless connectivity to the user's personal computer for accessing audio files stored on the computer.

Finally, it includes a built-in fast Ethernet port, and a PC Card slot for an optional WiFi or cellular broadband card 170. It includes a minimum of 40 GB of hard drive-based storage 180, capable of storing over 65 hours of CD quality sound, or 650 hours of 128 bit per second MP3 quality sound. Besides its PAR capability, the principal differentiators are the user interface, and the connectivity to portable audio devices.

The programmable radio 110 is programmed through an intuitive user interface that allows selection of the internet radio station or play list content. The myriad of available stations and programs make the process of finding a station laborious without a simple user interface. The first half of the interface creation process is accomplished through the on-line service, described below. The station lists, custom stations, play lists, and recording schedule are then sent to the programmable radio once completed on-line. The radio's interface allows the user to intuitively navigate through these options.

The feature that differentiates the inventive system and method from all other Internet radio hardware is that it allows the user to receive and store digital content for selective playback at any location, any time, and as frequently as desired.

The programmable radio serves as a docking station for digital audio players, such as MP3 player, and most principally in the current market, the IPOD®. The radio user interface allows the user to push recorded content to the IPOD® for playback when and where the user prefers. (IPOD is a registered trademark of Apple Computer, Inc., of Cupertino, Calif.)

Internet-Based Service-Interface. The on-line Internet-based service interface 200 is the control center at which users construct the content environment they desire. This interface includes the following information and functionality:

(a) Station and program guides 210 (by station, content, region, etc.)

(b) Intelligent agent interface 220

(c) Search—Sort—Select features 230

(d) Intelligent recommendations 240 (similar to Amazon book recommendations)

(e) Design a Station utility 250, allowing users to construct a station with the programming they want (leveraging the PAR technology)

(f) Community features

(g) Make recommendations back to the service—add meta-data to programs and stations, suggest additions to categories and station lists

(h) Share custom designed stations 260

(i) Optional access to the user's library of music stored on a personal computer

(j) The web-based service interface 200 makes it accessible from any computer with Internet access, allowing the user to change settings from anywhere in the world, at any time of the day—a simple log-in opens up the user's personal homepage, and at the user's command, all the preferences are sent to the programmable radio for immediate use.

The wireless network service and user information database 300 includes means for creating and storing a user information database with persistent user information 310 (such as account information), volatile user information 320 (such as station and playlist menus), and premium content 330. Through the Internet-based user interface 200, the user accesses the program guide 340 and selects the streaming digital content 350 to be delivered by the network server to the client's PAR for recording and selective playback. As will be readily appreciated, the programmable radio is always on when connected to the network via the router, hub, or other access device. Once connected, the programmable radio can be programmed to receive and record any digital content made available through the web-based service interface 200 at the program time.

Collection and Use of Marketing Data. The digital nature of the inventive system and method facilitates the collection of vast amounts of user preference data. Within the boundaries of a protective privacy policy, aggregated use data that is not tied to specific users is collected for sale to content providers. With the global expansion of Internet radio, local advertising ratings are insufficient. The inventive system and method provides data about the entire market. Additional rich data may be collected, from user's who opt-in, to a program that gives bonus premium-content points for use of extended demographic data.

Premium Content Arbitrator. Content providers 500 produce premium content. The inventive system and method can arbitrate access through a content arbitrator 510 to the premium content through its online service, and handle revenue collection and servicing 520 for the content providers. This content may include subscription-based online music services, private on-line stations, and special events broadcasts (e.g. music concerts).

The service can also include WiFi enabled mobile computing or audio devices 400, such as personal digital assistants (PDA), mobile phones, or (in the future) WiFi enabled car radios. The user can access the web-based service interface through their mobile device, which can also record the streamed audio on its internal hard drive. All the functionality of the service is available on a single device.

Having fully described several embodiments of the present invention, many other equivalents and alternative embodiments will be apparent to those skilled in the art. These and other equivalents and alternatives are intended to be included within the scope of the present invention.

What is claimed as invention is:

1. An Internet-based and computer-implemented system for delivering and recording streaming digital content, said system comprising:
a programmable radio, including a base station and a portable storage and playback device;
an Internet-based service interface;
a broadband router capable of delivering programming to hard wired and/or WiFi enabled devices; and
a wired or wireless network server and user information database for collecting, storing, organizing, and delivering streaming digital content services to consumers listening to radio.

2. The system of claim 1 wherein said network server provides station lists to the user of said system with which to program said programmable radio.

3. The system of claim 1, wherein said programmable radio includes a docking station for a portable digital audio player.

4. The system of claim 1 wherein said programmable radio has stand-alone broadband connectivity.

5. The system of claim 1 wherein said Internet-based service interface includes station and program guides, an intelligent agent interface, search/sort/select functionality, and design-a-station utility for allowing users to construct a station with desired programming, recommendation-to-network-service functionality.

6. The system of claim 1 wherein said wireless network server and user information

7. The system of claim 1 wherein said wireless network server and user information database includes means for providing marketing data collected from said user.

8. The system of claim 1 wherein said wireless network utilizes a content arbitrator for providing access to premium content.

9. The system of claim 8, wherein said content arbitrator includes means for revenue collection for said premium content.

10. The system of claim 1, further including means for streaming digital content stored on said programmable radio to an audio and/or visual playback device.

11. The system of claim 10, wherein said playback device is a cell phone.

12. A method of recording streaming digital content for playback at a user's discretion, said method comprising the steps of:
(a) providing a network server computer in communication with a global electronic computer network, said network server including storage means for storing an authorized user information database, a radio program guide, means for accessing digital content provided by content providers, and means for delivering streaming audio and/or video digital content to authorized user's in a standardized compression format;
(b) providing a programmable radio which includes a removable digital content storage device with electronic storage means, and a base station with stand-alone broadband connectivity;
(c) programming the programmable radio to request, receive, and record specified streaming digital content made available through the network service, such that the programmable radio will send an electronic request for digital content to be delivered at a specified program time;
(d) transmitting from the network server outgoing streaming digital content including the specified digital content requested by the authorized user at the specified program time;
(d) accepting at the programmable radio the streaming digital content as an incoming signal;
(e) recording the digital content on the storage device;
(f) at any time in the user's discretion, playing back the digital audio content using the storage device or other means of playing digital content from the storage device electronic storage means.

13. The method of claim 12, further including the step of collecting and distributing marketing data.

14. The method of claim 12, further including the step of arbitrating the provision of digital content.

15. The method of claim 14, wherein said digital content is premium digital content.

16. The method of claim 15, further including the step of collecting revenue for the provision of the premium digital content.

17. The method of claim 14, further including the step of collecting revenue for the provision of digital content.

18. The method of claim 12, further including the step of collecting revenue for the provision of digital content.
